(19) United States
(12) Patent Application Publication
(10) Pub. No.: US 2025/0068369 A1
(43) Pub. Date: Feb. 27, 2025

(54) SYSTEM, METHOD, AND RECORDING MEDIUM

(71) Applicant: CANON KABUSHIKI KAISHA, Tokyo (JP)

(72) Inventor: Hirofumi Mochizuki, Saitama (JP)

(21) Appl. No.: 18/772,444

(22) Filed: Jul. 15, 2024

(30) Foreign Application Priority Data
Aug. 22, 2023 (JP) 2023-134351

(51) Int. Cl. G06F 3/12

(52) U.S. Cl. CPC G06F 3/1275; G06F 3/1207; G06F 3/1253; G06F 3/1259; G06F 3/1287

(57) ABSTRACT

A system comprising a workflow construction unit configured to construct a workflow that executes actions as individual processes in a predetermined order, the workflow including a print action that is a process related to printing, by using a system coordinating with a workflow platform; a workflow execution unit configured to execute the workflow; and a print data transmission unit configured to transmit print data indicating a printed material to be printed by the print action to an image forming apparatus in a case where the print action is executed by the workflow execution unit.

### BACKGROUND OF THE INVENTION

### Field of the Invention

The present invention relates to a system, a method, and a recording medium.

### Description of the Related Art

In recent years, the use of chat applications, cloud services, and the like has increased. For example, there is a workflow platform that enables a user to construct a workflow by combining various in-house services or various external online services on a chat service. Such a workflow is data for executing actions, which are individual processes, in a predetermined order, and enables tasks to be automated. Additionally, in such a workflow platform, there is a case where a third party, for example, a user, a developer, and the like can add a function provided by an external online service to a workflow. For example, Japanese Patent Application Laid-Open No. 2020-42436 discloses a technology of providing a user interface for a process setting and a parameter setting of a process, which allows a user to easily perform the settings when a workflow is generated.

However, in the technology as disclosed in Japanese Patent Laid-Open No. 2020-42436, even if the user wants to include printing in the above-described tasks, the user is forced to operate a printer and the like separately from the execution of the workflow.

### SUMMARY OF THE INVENTION

A system of the present invention comprising: a workflow construction unit configured to construct a workflow that executes actions as individual processes in a predetermined order, the workflow including a print action that is a process related to printing, by using a system coordinating with a workflow platform; a workflow execution unit configured to execute the workflow; and a print data transmission unit configured to transmit print data indicating a printed material to be printed by the print action to an image forming apparatus in a case where the print action is executed by the workflow execution unit.

Further features of the present invention will become apparent from the following description of exemplary embodiments with reference to the attached drawings.

### BRIEF DESCRIPTION OF THE DRAWINGS

FIG. 1 is a diagram showing an overall configuration of a system according to the embodiment.

FIG. 2 is a hardware configuration diagram of an image forming apparatus acc ording to the embodiment.

FIG. 3 is a hardware configuration diagram of a client PC, a workflow platform, and print a service according to the embodiment.

FIG. 4 is a software configuration diagram of a system according to the embodiment.

FIG. 5 is a diagram showing a workflow list screen displayed on a chat service in the system according to the embodiment.

FIG. 6 is a diagram showing a screen for setting a trigger of a workflow displayed on the chat service in the system according to the embodiment.

FIG. 7 is a diagram illustrating a screen for setting an action of a workflow displayed on the chat service in the system according to the embodiment.

FIG. 8 is a diagram illustrating a screen for setting details of a trigger or an action of a workflow displayed on the chat service in the system according to the embodiment.

FIG. 9 is a flowchart illustrating file trigger setting processing in the embodiment.

FIG. 10 is a flowchart illustrating file acquisition action setting processing in the embodiment.

FIG. 11 is a flowchart illustrating processes executed by a workflow platform that indicates a print action in the embodiment.

FIG. 12 is a flowchart illustrating processes executed by a print service indicating the print action in the embodiment.

FIG. 13 is a flowchart illustrating processes executed by a workflow platform that indicates a reservation printing action in the embodiment.

FIG. 14 is a flowchart illustrating processes executed by a workflow platform that indicates a notification action in the embodiment.

FIG. 15 is a flowchart illustrating processes executed by a workflow platform during execution of a workflow in the embodiment.

FIG. 16 is a flowchart illustrating processes executed by a print service during execution of a workflow in the embodiment.

FIG. 17 is a flowchart illustrating printing processes performed by a printer during execution of a workflow in the embodiment.

FIG. 18 is a flowchart illustrating processes of reservation printing performed by a printer during execution of a workflow in the embodiment.

FIG. 19 is a flowchart illustrating processes in which the chat service transmits and receives a notification request during execution of a workflow according to the embodiment.

### DESCRIPTION OF THE EMBODIMENTS

Hereinafter, the embodiments for implementing the present invention will be explained with reference to the drawings. Note that the embodiments to be explained below do not limit the invention according to claims. Additionally, not all of the features described in the following embodiments are essential to the present invention.

### Embodiment

A system according to the embodiment includes a workflow construction unit, a workflow execution unit, and a print data transmission unit. The workflow construction unit is a workflow in which actions, which are individual processes, are executed in a predetermined order, and constructs a workflow including a print action, which is a process related to printing, by using a system coordinating with a workflow platform. The workflow execution unit executes a workflow. In a case where a print action is executed by the workflow execution unit, a print data transmission unit transmits print data indicating a printed material to be printed by a print action to an image forming apparatus. In this case, it is possible to provide a system, a method, and a program in which a print action, which is a process related to printing, can be included in the workflow.

Additionally, the workflow execution unit executes the workflow by executing a plurality of actions in a predetermined order.

Additionally, the system according to the embodiment may further include a list acquisition unit that acquires a list of image forming apparatuses that can be used in coordination with the print data transmission unit in a case where the workflow including a print action is constructed by the workflow construction unit.

Additionally, the list acquisition unit may acquire the list of the image forming apparatuses from the print data transmission unit after confirming that the workflow platform and the print data transmission unit have already been coordinated.

Additionally, the system according to the embodiment may further include a print setting acquisition unit that acquires data related to a print setting related to the print action from the list acquisition unit, according to the image forming apparatus selected from the list acquired by the list acquisition unit.

Additionally, the print setting acquisition unit may acquire the data related to the print setting related to the print action by transmitting a print setting acquisition request to the print data transmission unit.

Additionally, the workflow execution unit may execute the workflow in a case where a workflow execution button provided to a client terminal by the chat service and displayed by a client terminal is pressed down.

Additionally, the workflow construction unit may construct the workflow including the print action, based on data provided to the client terminal by the chat service and input to a workflow edit screen displayed by the client terminal.

Additionally, the workflow construction unit may determine the content of a print action, based on data provided to the client terminal by the chat service and input to a print action setting screen displayed by the client terminal.

Additionally, the workflow execution unit may provide a notification by using a chat service when printing is successful or printing has failed.

Additionally, the workflow execution unit may provide a notification by using a print execution unit when printing is successful or printing has failed.

Additionally, the workflow execution unit may provide a notification by using a chat service when the approval processing is executed.

Hereinafter, preferred embodiments of the above-described invention will be explained with reference to the drawings.

### Overall Configuration

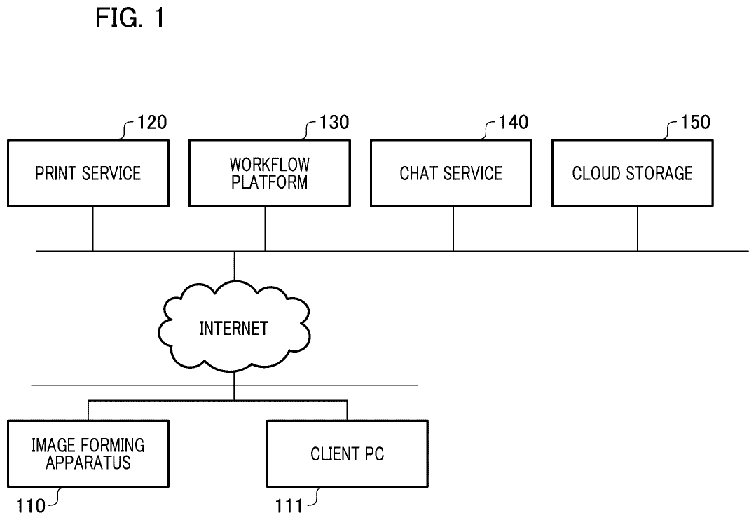

FIG. 1 is a diagram showing an overall configuration of a system according to the embodiment. The workflow system includes a workflow platform 130, a print service 120, a chat service 140, a cloud storage 150, an image forming apparatus 110, and a client PC 111.

The workflow platform 130 is a server that provides a workflow construction unit that constructs a workflow by using a system coordinating with the workflow platform 130. The workflow is data for executing actions, which are individual processes, in a predetermined order. The action is, for example, processing of printing performed by the image forming apparatus 110 and the like, processing of reservation printing performed by the image forming apparatus 110 and the like, and processing of scanning performed by the image forming apparatus 110 and the like. Additionally, processing related to printing, such as processing of printing performed by the image forming apparatus 110 and the like and processing of reservation printing performed by the image forming apparatus 110 and the like, may be referred to as a print action. Additionally, processing related to scanning, such as processing of scanning performed by the image forming apparatus 110 and the like, may be referred to as a scan action. Furthermore, the action is not limited to the processing related to printing or scanning, and may be processing in which the image forming apparatus 110 and the like is not involved, such as an approval request, a notification request, storage of file, conditional branching, and repetitive processing.

Additionally, a system coordinating with the workflow platform 130 is provided by, for example, an OS (Operating System) developer. Further, it is preferable that a trigger, which is a condition of starting execution, is set in the workflow. Additionally, the workflow is executed by a workflow execution unit.

Additionally, the workflow platform 130 may have a customization function that coordinates with an online service provided by a company other than the OS developer. Additionally, the online service is, for example, a cloud storage and a chat service. Since the workflow platform 130 has a customization function, it is possible to create a workflow in coordination with more services.

The print service 120 is a server that provides a print data transmission unit that transmits print data indicating a printed material to be printed by a print action to the image forming apparatus 110 in a case where the print action, which is a process related to printing, is executed by the workflow execution unit. The print service 120 is connected to the client PC 111 and the image forming apparatus 110. In a case where a print action is executed by a workflow execution unit included in the client PC 111, the print service 120 receives data and printer data indicating the print action is to be executed, from the client PC 111. Then, the print service 120 transmits data indicating that the print action is to be executed and print data to the image forming apparatus 110, and causes the image forming apparatus 110 to execute printing.

The chat service 140 is a server that provides a communication service for providing a chat function to the client PC 111. As shown in FIG. 1, the chat service 140 is connected to the Internet. Additionally, the chat service 140 may have a function that notifies a user other than the chat function, such as a mail function, an approval function, and a task management function.

The cloud storage 150 is a service capable of storing a file via the Internet and acquiring a file in a web browser.

The client PC 111 includes the above-described workflow execution unit. The client PC 111 is, for example, a personal computer, a tablet, and a smartphone, and is connected to the Internet as shown in FIG. 1. The client PC 111 causes a user interface necessary for using the functions of the workflow platform 130, the print service 120, the chat service 140, the cloud storage 150, and the like to be displayed on a display. Note that the display may be mounted on the client PC 111, or may be independent of the client PC 111 and connected to the client PC 111. The image forming apparatus 110 is, for example, a multifunction peripheral and a printer.

Although an example of the configuration of the system according to the embodiment comprising the workflow platform 130, the print service 120, the chat service 140, a cloud storage 150, the image forming apparatus 110, and the client PC 111 has been described, the present invention is not limited thereto.

### Hardware Configuration of Printer

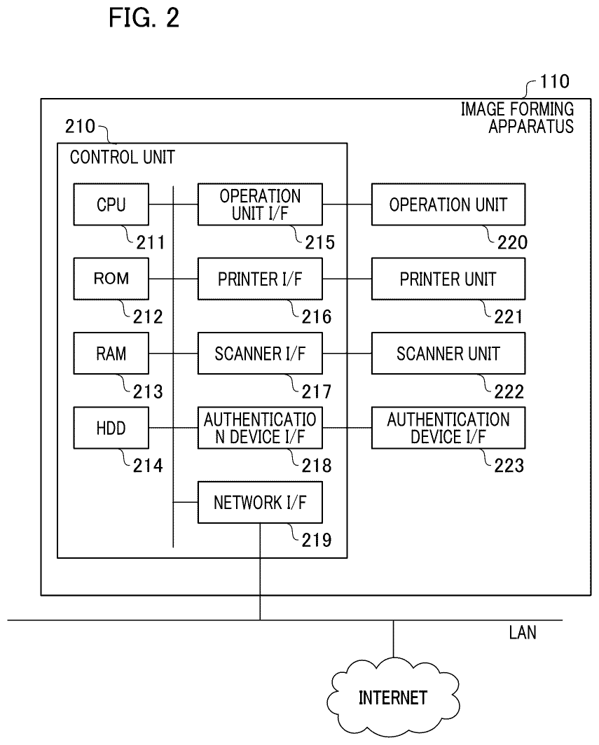

FIG. 2 is a hardware configuration diagram of an image forming apparatus according to the embodiment. The image forming apparatus 110 is configured by a control unit 210, an operation unit 220, a printer unit 221, a scanner unit 222, and an authentication device 223.

As shown in FIG. 2, the control unit 210 includes a central processing unit (CPU) 211, a read only memory (ROM) 212, a random access memory (RAM) 213, and a hard disk drive (HDD) 214. Additionally, as shown in FIG. 2, the control unit 210 includes an operation unit I/F 215, a printer I/F 216, a scanner I/F 217, an authentication device I/F 218, and a network I/F 219. The control unit 210 controls the overall operation of the image forming apparatus 110.

The CPU 211 reads out a control program stored in the ROM 212, and executes and controls various functions of the image forming apparatus 110 such as reading, printing, and communication. The ROM 212 stores the control program. The RAM 213 is used as the main memory of the CPU 211, and temporary storage regions such as a work area and the like. The HDD 214 is a large-capacity storage unit that stores image data, various programs, and the like.

Although, in the present embodiment, one CPU 211 executes each process as shown in a flowchart to be described below by using one RAM 213 or one HDD 214, the present invention is not limited thereto. For example, a plurality of CPUs and a plurality of RAMs or a plurality of HDDs may coordinate to execute each process.

The operation unit I/F 215 is an interface that connects the operation unit 220 and the control unit 210. The operation unit 220 is a touch panel, a keyboard, and the like, and receives operations, inputs, instructions, and the like from a user.

The printer I/F 216 is an interface that connects the printer unit 221 and the control unit 210. The printer unit 221 receives image data to be printed included in the above-described print job via the printer I/F 216, and executes printing.

The scanner I/F 217 is an interface that connects the scanner unit 222 and the control unit 210. The scanner unit 222 reads a document set on a document table, an auto document feeder (ADF), and the like (not illustrated), and generates image data. Then, the scanner unit 222 transmits the image data to the control unit 210 via the scanner I/F 217.

The image forming apparatus 110 transmits image data generated by the scanner unit 222 to the printer unit 221. Then, the image forming apparatus 110 executes printing based on the image data. Note that the image forming apparatus 110 may have a function of externally transmitting a file or an e-mail.

The authentication device I/F 218 is an interface that connects the authentication device 223 and the control unit 210. The authentication device 223 is, for example, a card reader that reads IC cards, a fingerprint authentication device that reads a fingerprint, and the like, and is used when a user performs authentication in order to use the image forming apparatus 110.

The network I/F 219 is an interface that connects the control unit 210 to a LAN. The image forming apparatus 110 transmits image data and information to each service on the Internet by using the network I/F 219, and receives various kinds of information.

### Hardware Configurations of Client PC, Workflow Platform, and Print Service

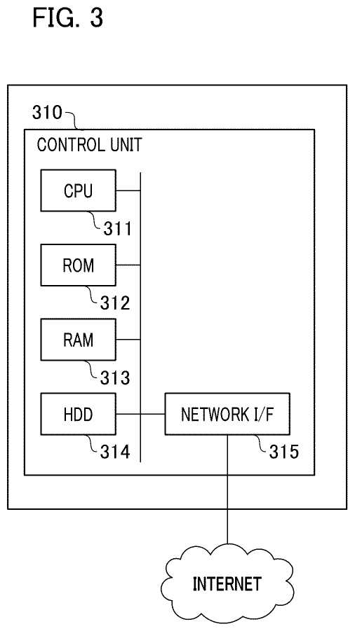

FIG. 3 is a hardware configuration diagram of a client PC, a workflow platform, and a service according to the embodiment. The client PC, the workflow platform, and the print service include a CPU 311, a ROM 312, a RAM 313, an HDD 314, and a network I/F 315.

The CPU 311 controls the overall operation by reading out a control program stored in the ROM 312 and executing various processes. The ROM 312 stores a control program. The RAM 313 is used as the main memory of the CPU 311, and temporary storage regions such as a work area and the like. The HDD 314 is a large-capacity storage unit that stores image data, various programs and the like. The network I/F 315 is an interface that is connected to the Internet. The network I/F 315 receives a processing request and the like from a device outside the control unit 310, and transmits and receives various kinds of information to and from devices outside the control unit 310.

### Software Configuration of Workflow System

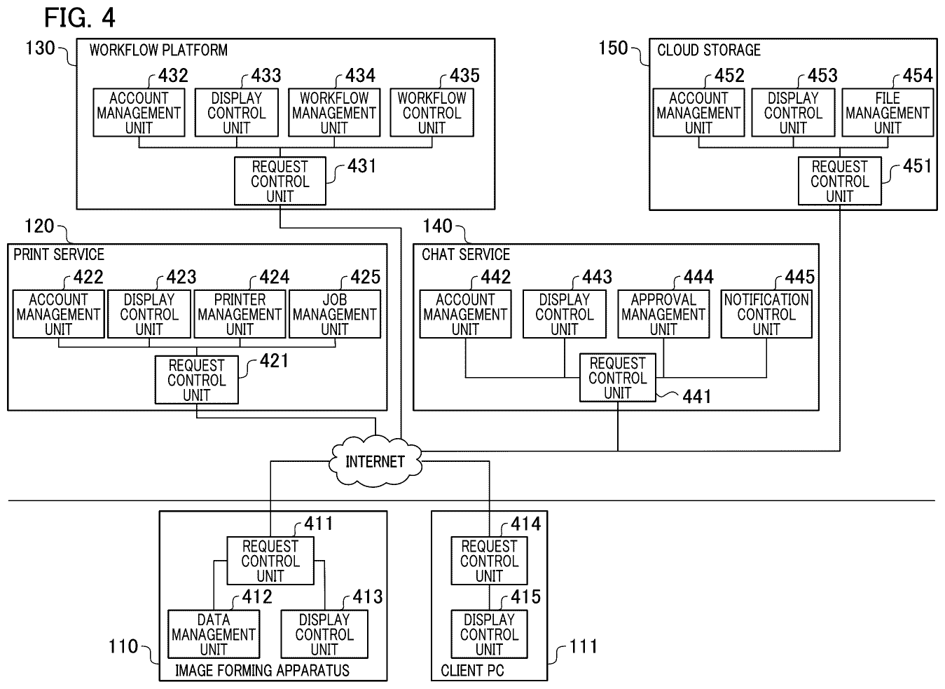

FIG. 4 is a software configuration diagram of a system according to the embodiment. The workflow platform 130 has a request control unit 431, an account management unit 432, a display control unit 433, a workflow management unit 434, and a workflow control unit 435.

The request control unit 431 is on standby in a state in which it can receive a request from the print service 120, the chat service 140, the cloud storage 150, the image forming apparatus 110, and the client PC 111. Additionally, in a case where the request is transmitted, the request control unit 431 receives the request.

The account management unit 432 manages account information for logging in to the workflow platform 130. Note that, in the present embodiment, the workflow platform 130 and a service other than the workflow platform 130 have different account information. However, the account management unit 432 may be configured to separately use an account management service shared to the workflow platform 130 and a service other than the workflow platform 130 to enable single sign-on with the same account. For example, the account management unit 432 may manage an account of the workflow platform 130 and an account of the chat service 140 as the same account.

The display control unit 433 receives a request from a web browser operating on the client PC 111, a terminal, for example, a mobile (not illustrated), which are connected via the Internet. Then, the display control unit 433 transmits screen configuration information necessary for screen display to the clients PC 111, a terminal, and the like based on the request. The screen configuration information is described in, for example, HTML (Hyper Text Markup Language), or CSS (Cascading Style Sheets).

The workflow management unit 434 manages the construction of a workflow, the editing of a workflow, the storage of a workflow, and the like. The work flow control unit 435 controls execution, stop, and the like of the workflow stored in the workflow management unit 434 in response to a workflow execution request that has been received by the request control unit 431.

The print service 120 has a request control unit 421, an account management unit 422, a display control unit 423, a printer management unit 424, and a job management unit 425.

The request control unit 421 is on standby in a state in which it can receive a request from the image forming apparatus 110 and the workflow platform 130. Additionally, in a case where the request is transmitted, the request control unit 421 receives the request.

The account management unit 422 manages account information for logging in to the print service 120. Additionally, the account information may be associated with user information used for logging in to the image forming apparatus 110.

The display control unit 423 receives a request from a web browser operating on the client PC 111, a terminal, for example, a mobile (not illustrated), which are connected via the Internet. Then, the display control unit 423 and the display control unit 433 transmit screen configuration information necessary for screen display to the clients PC 111, the terminals, and the like based on the request. The screen configuration information is described in, for example, HTML or CSS.

The printer management unit 424 manages an image forming apparatus, for example, the image forming apparatus 110 registered in the print service 120. Additionally, the printer management unit 424 can acquire information indicating the status, printing performance, scanning performance, various settings, and the like of an image forming apparatus, for example, the image forming apparatus 110 registered in the print service 120.

The job management unit 425 receives and manages print and scan jobs from the workflow platform 130, the client PC 111, and the chat service 140. In response to the request, the job management unit 425 transmits the managed job to the printer registered in the print service 120 and causes the printer to execute the job.

The chat service 140 has a request control unit 441, an account management unit 442, a display control unit 443, an approval management unit 444, and a notification control unit 445.

The request control unit 441 is on standby in a state in which it can receive a request from the client PC 110, the print service 120, or the workflow platform 130. Additionally, in a case where the request is transmitted, the request control unit 441 receives the request.

The account management unit 442 manages account information for logging into the chat service 140. Additionally, the account management unit 442 may be configured to separately use an account management service shared with the chat service 140 and a service other than the chat service 140 to enable single sign-on with the same account.

The display control unit 433 receives a request from a web browser operating on the client PC 111 and a terminal, for example, a mobile (not illustrated), which are connected via the Internet. Then, the display control unit 443 transmits screen configuration information necessary for screen display to the client PC 111, the terminal, and the like based on the request. The screen configuration information is described in, for example, HTML or CSS.

The approval management unit 444 receives an approval request from a service other than the chat service 140, such as the workflow system 130 and the print service 120. Then, the approval management unit 444 transmits an approval request to the account registered in the chat service 140, and manages the approval status related to the approval request. The client PC 111 receives an operation by the user of the chat service 140, and transmits an approval request to an account of another user registered in the chat service 140. In this case, the account that has received the approval request can execute approval or disapproval processing.

The notification control unit 445 receives a notification request from a service other than the chat service 140, such as the workflow system 130 and the print service 120, and executes notification to an account registered in the chat service 140.

The cloud storage 150 has a request control unit 451, an account management unit 452, a display control unit 453, and a file management unit 454.

The request control unit 451 is on standby in a state in which it can receive a request from the client PC110, the print service 120, and the workflow platform 130. Additionally, in a case where the request is transmitted, the request control unit 451 receives the request.

The account management unit 452 manages account information for logging in to the cloud storage 150. Additionally, the account management unit 452 may manage the cloud storage 150 and a service other than the cloud storage 150 as the same account.

The display control unit 453 receives a request from a web browser operating on the client PC 111 and another terminal, for example, a mobile (not illustrated), which are connected via the Internet. Then, the display control unit 453 transmits screen configuration information necessary for screen display to the clients PC 111, the terminals, an d the like based on the request. The screen configuration information is described in, for example, HTML or CSS.

The file management unit 454 manages files stored in the cloud storage 150. Additionally, the file management unit 454 executes saving, changing, deleting, sending, and the like of a file in response to a request.

The image forming apparatus 110 has a request control unit 411, a data manage ment unit 412, and a display control unit 413.

The request control unit 411 is on standby in a state in which it can receive a request from the print service 120. Additionally, in a case where the request is transmitted, the request control unit 411 receives the request. For example, in a case where the request control unit 411 receives a processing request, the request control unit 411 appropriately instructs at least one of the display control unit 413 and the data management unit 434 to execute processing corresponding to the processing request. The data management unit 412 manages user information, connection information with the print service 120, and the like. The display control unit 413 causes a touch panel display mounted on the operation unit 220 of the image forming apparatus 110 to display a user interface for receiving an operation by a user.

Although, in the above explanation, the case where the image forming apparatus connected to the print service 120 is only the image forming apparatus 110 has been explained, a plurality of image forming apparatuses may be connected to the print service 120.

In a case where the image forming apparatus 110 has been registered in the print service 120, the image forming apparatus 101 constantly or periodically executes communication with the print service 120 so as to receive a request from the print service 120.

The client PC 111 has a request control unit 414 and a display control unit 415. The client PC 111 accesses the print service 120, the workflow platform 130, the chat service 140, or the cloud storage 150 via the request control unit 414. The display control unit 415 displays a user interface necessary for operating the workflow platform 130, the print service 120, the chat service 140, and the like.

### Flow of Processing

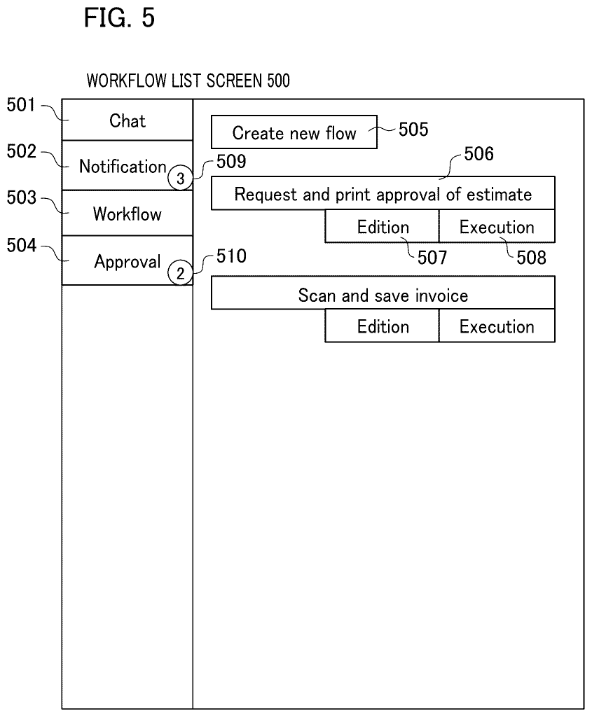

First, a procedure in which the workflow platform 130 constructs a workflow will be explained. FIG. 5 is a diagram showing a workflow list screen displayed on a chat service in the system according to the embodiment. The chat service 140 coordinates with the workflow platform 130 by being authenticated by an account of the workflow platform 130. The client PC 111 causes the workflow list screen 500 provided by the chat service 140 to be displayed on a display. Note that, as described above, the account of the chat service 140 may be the same as the account of the workflow platform 130. In such a case, authentication for coordination is not necessary.

The workflow list screen 500 is divided into a sidebar and a main screen.

The sidebar includes a transition button 501, a transition button 502, a transition button 503, and a transition button 504. When the transition button 501 is pressed down by a user, the screen displayed on the display is transitioned to the chat screen. When the transition button 502 is pressed down by a user, the screen displayed on the display is transitioned to a notification screen. When the transition button 503 is pressed down by a user, the screen displayed on the display is transitioned to the workflow list screen 500. When the transition button 504 is pressed by a user, the screen displayed on the display is transitioned to an approval screen. Additionally, the sidebar continues to be displayed even when the screen displayed on the display is transitioned to the chat screen, the notification screen, or the workflow list screen 500.

The main screen includes a new workflow creation button 505, a title display field 506, an edit button 507, and an execution button 508. The new workflow creation button 505 is pressed down when a workflow is created. The title display field 506 is a field in which the title of the created workflow is displayed. An edit button 507 is pressed down when the workflow is edited. An execution button 508 is pressed down when the workflow is executed. Additionally, in the main screen, the chat screen, the notification screen, or the workflow list screen 500 as described above is displayed.

The workflow list screen 500 is used to create a workflow, edit a workflow, and execute a workflow. Note that the workflow is created such that the start condition of the workflow becomes a specific date and time and a specific action. In such a case, the content of the specific action that becomes the start condition may be manually or automatically set in advance, and the workflow may be executed when the workflow execution button 508 is pressed down.

The notification badge 509 is a badge indicating the number of unread notifications that have arrived at the chat service 140. In a case where the number of unread notifications is 0, the notification badge 509 is not displayed. The approval notice badge 510 is a badge indicating the number of unprocessed approval notices that have arrived at the chat service 140. In a case where the number of unprocessed approval notices is 0, the approval notice badge 510 is not displayed.

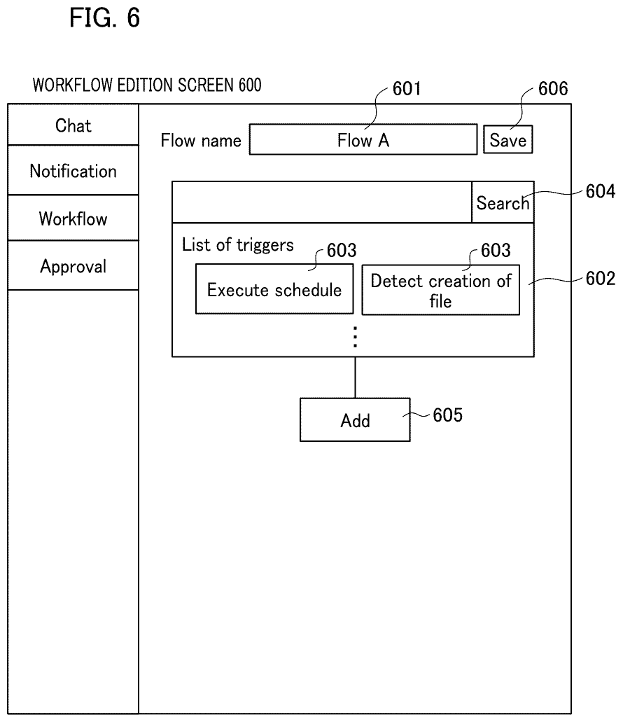

FIG. 6 is a diagram showing a screen for setting a trigger of a workflow displayed on the chat service in the system according to the embodiment. The client PC 111 causes the workflow editing screen 600 provided by the chat service 140 to be displayed on a display.

Similar to the workflow list screen 500, the workflow edit screen 600 is divided into two screens of a sidebar and a main screen.

The sidebar of the workflow edit screen 600 is similar to the sidebar of the workflow list screen 500. The main screen of the work flow edit screen 600 includes a work flow name edit box 601, a work flow trigger list screen 602, a work flow trigger selection button 603, a work flow trigger search button 604, a work flow action addition button 605, and a work flow save button 606.

When the workflow name is edited, a workflow name is input in a workflow name edit box 601.

As described above, in the workflow, it is preferable that a trigger that is a condition for starting execution is set. Therefore, the workflow edit screen 600 is configured such that the trigger is set before the action. The work flow trigger list screen 602 displays a list of triggers that can be used in the workflow platform 130. The trigger is, for example, a schedule trigger that periodically starts a workflow, a file trigger that is executed when the arbitrary cloud storage 150 is updated, a scan trigger that is executed when scanning starts in the image forming apparatus 110, and the like.

The work flow trigger selection button 603 is a button that is pressed down for selecting a trigger of a workflow. For example, as shown in FIG. 6, the workflow edit screen 600 displays a workflow trigger selection button 603 for selecting execution of a schedule as a trigger. Additionally, for example, as shown in FIG. 6, the workflow editing screen 600 displays a workflow trigger selection button 603 for selecting detection of creation of a file as a trigger.

In a case where the work flow trigger selection button 603 is pressed down, and an external service that provides a trigger corresponding to the button and an account logged in to the workflow platform 130 have already been coordinated, a trigger setting screen is displayed. In contrast, in a case where the external service that provides a trigger corresponding to the button and the account logged in to the workflow platform 130 have not been coordinated, an authentication screen for coordinating both is displayed, and the trigger setting screen is displayed after the authentication is performed.

The workflow trigger search button 604 is used for searching for a trigger displayed on the work flow trigger list screen 602, and enables a search for a trigger by an input character string. For example, the target of the search is a trigger related to the workflow platform 130. Alternatively, the target of the search is a trigger related to a service other than the workflow platform 130, such as a trigger related to the print service 120. For example, in a case where a character string “save” is input and searched for, a list of triggers related to saving, such as an action that is triggered by the data being saved in the cloud storage 150, is displayed. Additionally, for example, in a case where a character string “scan” is input and searched for, a list of triggers and the like for starting a workflow by the print service 120 executing scanning is displayed. The trigger is determined by selecting the trigger by such a search.

The workflow action addition button 605 is pressed down to display a workflow action addition screen. A workflow save button 606 is pressed down to save the edited workflow.

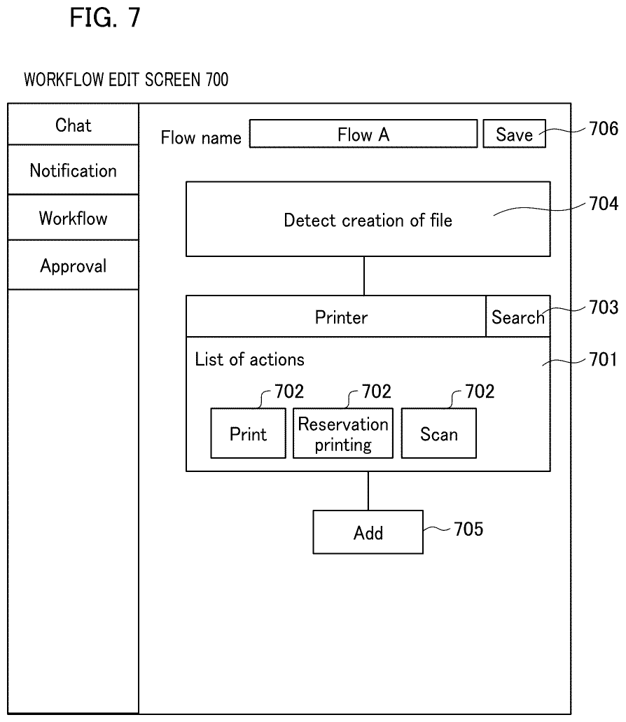

FIG. 7 is a diagram illustrating a screen for setting an action of a workflow displayed on the chat service in the system according to the embodiment. As described above, the action corresponds to each process. Additionally, the action executes transmission and reception of some data to and from a service other than the workflow platform 130, and controls the workflow itself such as standby, branching, and repetition in the workflow.

The sidebar of the workflow edit screen 700 is similar to the sidebar of the workflow list screen 500. The main screen of the workflow edit screen 700 includes a workflow action list screen 701, a workflow action selection button 702, and a workflow action search button 703. Additionally, the main screen of the workflow edit screen 700 includes a workflow trigger button 704, a workflow action addition button 705, and a workflow save button 706.

The workflow action list screen 701 displays a list of actions that can be used in the workflow platform 130. For example, as shown in FIG. 7, the workflow action list screen 701 displays a plurality of workflow action selection buttons 702 corresponding to each action. In a case where the workflow action selection button 702 is pressed down and the external service that provides the corresponding action and the account logged in to the workflow platform 130 have already been coordinated with each other, an action setting screen is displayed. In contrast, in a case where both have not been coordinated with each other even when the workflow action selection button 702 is pressed down, an authentication screen for performing coordination is displayed, and after both have been authenticated, an action setting screen is displayed.

A workflow action search button 703 is used for searching for a workflow action displayed on the workflow action list screen 701, and enables a search for an action by an input character string. The search target is, for example, an action related to the workflow platform 130, an action related to a service other than the workflow platform 130, and an action related to the print service 120. For example, when a character string “notification” is input and searched for, a list of actions for the chat service 140 to notify an arbitrary user, group, and the like is displayed. Additionally, for example, in a case where a character string “save” is input and searched for, a list of actions related to saving, such as saving data in a cloud storage, is displayed. Additionally, for example, in a case where a character string “print” is input and searched for, a list of actions related to printing performed by the print service 120 is displayed. The action that the user wants to include in the workflow is selected by the search as described above, and the action included in the workflow is determined.

The workflow trigger button 704 is a button that displays a name of a trigger that has already been set. When the workflow trigger button 704 is pressed down, a trigger edit screen is displayed.

In a case where the workflow action addition button 705 is pressed down, a new workflow action list screen 701 is displayed under the workflow action list screen 701 that has already been displayed. Thus, a workflow in which a plurality of actions are combined is created. A workflow save button 706 is pressed down for saving the created workflow.

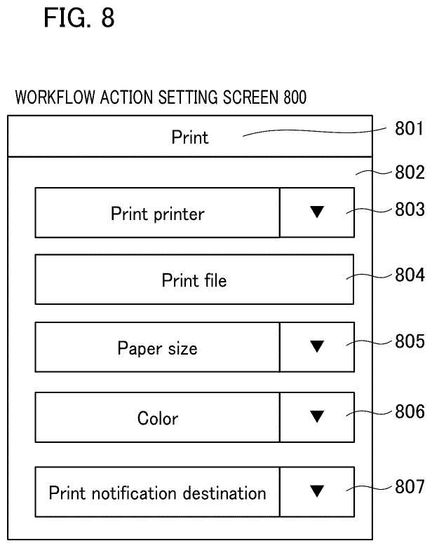

FIG. 8 is a diagram illustrating a screen for setting details of a trigger or an action of a workflow displayed on the chat service in the system according to the embodiment. In FIG. 8, a workflow action setting screen 800 for performing the setting related to a print action is illustrated as an example. The workflow action setting screen 800 includes an action name display field 801 and an action setting list 802. The action setting list 802 includes an action setting 803, an action setting 804, an action setting 805, an action setting 806, and an action setting 807. These action settings are user interfaces for receiving settings related to actions, and for example, input of a free character string or input of a value acquired by a previous or subsequent action is received, or an option is provided. Additionally, the option may also be acquired from a service other than the workflow platform 130 and displayed. Additionally, the above explanation regarding the settings of the print action also applies to the trigger settings.

In the action name 801, an action name is displayed. Additionally, the action name may be freely changeable by a user.

The action setting 803 is used for specifying an image forming apparatus to execute printing. The image forming apparatus selectable here is an image forming apparatus registered in the print service 120.

An action setting 804 is used for specifying a file to be print processed. For example, in the action setting 804, a trigger to be executed prior to the print action, a file to be acquired by the action, a URL indicating the file, and the like are specified. Additionally, as such a file, for example, a file acquired from the cloud storage 150 is exemplified.

Action setting 805 is used for providing an option that specifies a paper size. A ction setting 806 is used for providing an option that specifies color settings for printing. These two are examples of the print settings, and more detailed print settings may be specified. The print settings depend on the performance of the printer used for printing. For this reason, the action setting 805 and the action setting 806 receive selectable print settings from the print service 120 after the image forming apparatus is specified in the action setting 803, and display the print settings as options. Additionally, for the print setting, a value acquired by a trigger or an action executed before the print action may be used. Additionally, in a case where a plurality of print settings conflict with each other, a measure, for example, gray-out, invalidation and the like of a print setting that cannot be selected at the same time may, be taken.

The action setting 807 is used for setting the presence or absence of a notification regarding printing, the content of the notification, and the transmission destination of the notification. Additionally, as a transmission destination of the notification, an account or a group of the workflow platform 130 or an arbitrary account or group of the chat service 140 or the print service 120 in coordination can be selected. Alternatively, the workflow platform 130 or the print service 120 may determine the transmission destination from among a client PC 111 that instructs execution of the workflow, a client PC 111 that performs operation after the workflow such as execution of printing, and the like, depending on the content of error.

Although, in the above explanation, a case where notification is set as a setting of a workflow including a print action has been explained as an example, the workflow platform 130 may construct a workflow so as to acquire and notify the result of a print action. Additionally, only a specific notification from among various types of notifications may be an independent action, and the other notifications may be included in the print action. For example, only the notification indicating that printing is successful may be an independent action, and a notification indicating that printing has failed may be included in the print action. As a result, the notification indicating that printing has failed need not be incorporated into the workflow as an independent action.

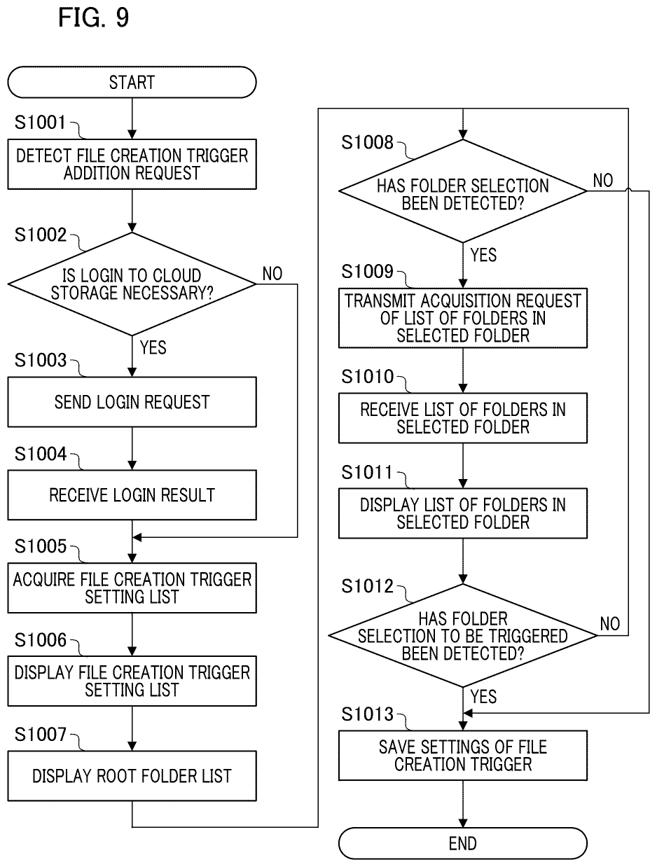

Next, a procedure for actually connecting to each service and performing the setting in order to construct a workflow will be explained with reference to FIG. 9. FIG. 9 is a flowchart illustrating file trigger setting processing in the embodiment. Specifically, FIG. 9 illustrates details of a procedure in which the workflow platform 130 constructs a workflow in coordination with the cloud storage 150. In the present embodiment, an example will be described in which a workflow is constructed with a file creation trigger for executing the workflow as a workflow trigger when a file is created.

In step S1001, the workflow platform 130 detects a file creation trigger addition request.

In step S1002, the workflow platform 130 confirms whether or not coordination with the cloud storage 150 that provides a file creation trigger is set, and verifies whether or not login to the cloud storage 150 is necessary. In a case where the workflow platform 130 determines that login to the cloud storage 150 is necessary, the process advances to step S1003. In contrast, in a case where the workflow platform 130 determines that login to the cloud storage 150 is not necessary, the process advances to step S1005.

In step S1003, the workflow platform 130 transmits a login request to the cloud storage 150.

In step S1004, the workflow platform 130 receives the login result from the cloud storage 150. Additionally, after execution of the process in step S1004, the workflow platform 130 can communicate with the cloud storage 150 on the assumption that the coordination with the cloud storage 150 has already been completed.

In step S1005, the workflow platform 130 acquires a list of file creation trigger settings.

In step $1006, the workflow platform 130 displays the list of file creation trigger settings. Note that each setting option is an option that has been acquired from a service other than the workflow platform 130. Additionally, in this case, it is assumed that options of each setting are options that are acquired from the cloud storage 150 coordinating with the workflow platform 130.

In step S1007, the workflow platform 130 displays a list of root folders of the cloud storage 150. Note that the reason why the process of step S1007 is executed is that, in a case where the file creation trigger is adopted as the trigger, it is necessary to specify a folder in which a file is created and the file creation trigger is executed.

In step S1008, the workflow platform 130 determines whether or not selection of an arbitrary folder from the list has been detected. In a case where the workflow platform 130 determines that selection of an arbitrary folder from the list has been detected, the process advances to step S1009. In contrast, in a case where the workflow platform 130 determines that the selection of an arbitrary folder from the list has not been detected, the process advances to step S1013.

In step S1009, the workflow platform 130 transmits a request for acquiring a list of folders in the selected folder.

In step S1010, the workflow platform 130 receives the list of folders in the selected folder.

In step S1011, the workflow platform 130 displays a list of folders in the selected folder.

In step S1012, the workflow platform 130 determines whether or not selection of a folder to be the target of the trigger has been detected. In a case where the workflow platform 130 determines that the selection of the folder to be the target of the trigger has been detected, the process advances to step S1013. In contrast, in a case where the workflow platform 130 determines that the selection of the folder to be the target of the trigger has not been detected, the process returns to step S1008.

The workflow platform 130 can incorporate the file creation trigger into an arbitrary workflow by executing the processes as shown in FIG. 9. Note that the file creation trigger provides the acquisition of metadata related to the file including the name, ID, time, and folder path of the file created in the action executed after the file creation trigger.

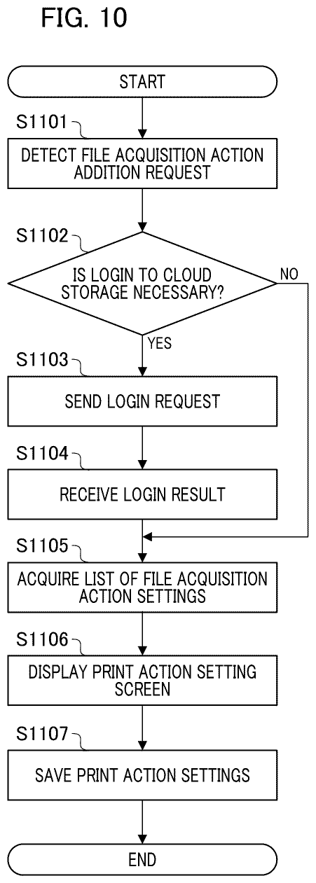

FIG. 10 is a flowchart illustrating file acquisition action setting processing in the embodiment. Specifically, FIG. 10 illustrates details of processing in which the workflow platform 130 constructs a workflow in coordination with the cloud storage 150. In the present embodiment, a case where the workflow platform 130 constructs a workflow by including, in the workflow, a file acquisition action of acquiring a file of the cloud storage 150 as an action of the workflow will be explained as an example. The file acquisition action is an action for acquiring the content of a specified file, a published URL, or a limited published URL.

In step S1101, the workflow platform 130 detects a file acquisition action addition request.

In step S1102, the workflow platform 130 confirms whether or not coordination with the cloud storage 150 that provides a file acquisition action has already been set, and determines whether or not login to the cloud storage 150 is necessary. In a case where the workflow platform 130 determines that a login to the cloud storage 150 is necessary, the process proceeds to step S1103. In contrast, in a case where the workflow platform 130 determines that the login to the cloud storage 150 is not necessary, the process proceeds to step S1105. For example, in a case where the processes of the flowchart as shown in FIG. 10 are executed, the workflow platform 130 determines that the login to the cloud storage 150 is not necessary because the coordination with the cloud storage 150 has already been set.

In step S1103, the workflow platform 130 sends a login request to the cloud storage 150.

In step S1104, the workflow platform 130 receives the login result from the cloud storage 150. Additionally, after the completion of the process in step S1104, the workflow platform 130 can communicate with the cloud storage 150 on the assumption that coordination with the cloud storage 150 has already been completed.

In step S1105, the workflow platform 130 acquires a list of settings of file acquisition actions.

In step S1106, the workflow platform 130 displays a print action setting screen. Note that, in the file acquisition action, a file to be acquired needs to be set. For example, the workflow platform 130 constructs a workflow so that a target file that can be acquired from a file path acquired by executing a file creation trigger can be specified.

In step S1107, the workflow platform 130 saves the settings of the print action.

The workflow platform 130 can incorporate a file acquisition action into an arbitrary workflow by the processes as shown in FIG. 10.

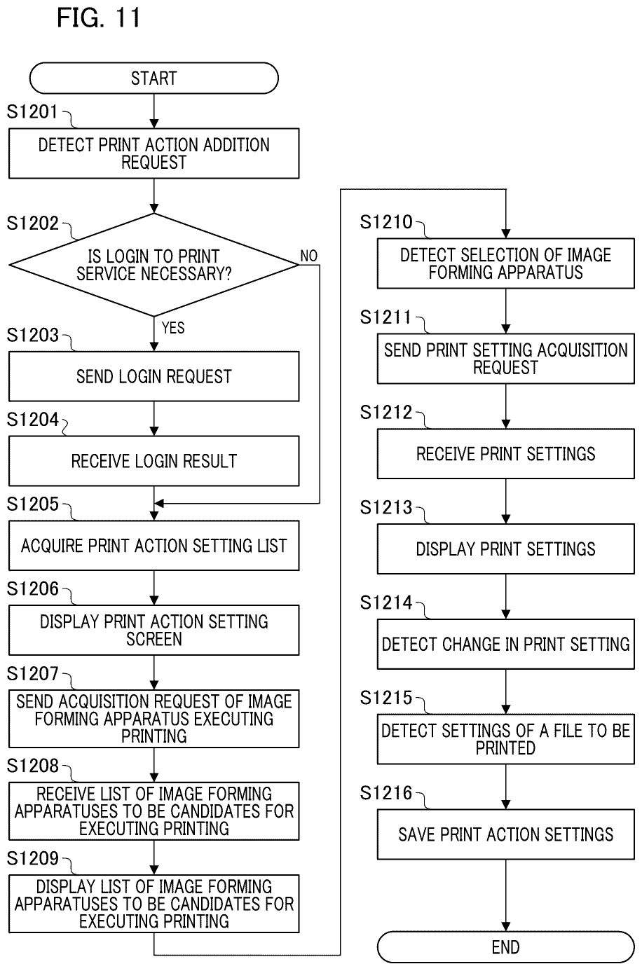

FIG. 11 is a flowchart illustrating processes executed by a workflow platform that indicates a print action in the embodiment. Specifically, FIG. 11 illustrates details of processing in which the workflow platform 130 constructs a workflow in coordination with the print service 120. In the present embodiment, an example in which an action of printing a file by a printer specified by the print service 120 is constructed as an action of a workflow will be explained.

In step S1201, the workflow platform 130 detects a print action addition request.

In step S1202, the workflow platform 130 confirms whether or not coordination with the print service 120 that provides a print action has already been set, and determines whether or not the login to the print service 120 is necessary. In a case where the workflow platform 130 determines that the login to the print service 120 is necessary, the process proceeds to step S1203. In contrast, in a case where the workflow platform 130 determines that login to the print service 120 is not necessary, the process advances to step S1205.

In step S1203, the workflow platform 130 transmits a login request to the print service 120.

In step S1204, the workflow platform 130 receives the login result from the print service 140. Note that, after execution of the process of step S1204, the workflow platform 130 can communicate with the print service 120 on the assumption that the coordination with the print service 120 has already been completed.

In step S1205, the workflow platform 130 acquires a list of print action settings.

In step S1206, the workflow platform 130 displays a print action setting screen. In a case where the print action is executed, an action setting list 803 for specifying a printer that executes printing is displayed, for example, as shown in FIG. 8. Additionally, in a case where the print action is executed, the action setting list 804, the action setting list 805, the action setting list 806, and the action setting list 807 for specifying the print setting and a file to be printed are displayed, for example, as shown in FIG. 8.

In step S1207, the workflow platform 130 transmits an acquisition request for acquiring an image forming apparatus that executes printing to the print service 120.

In step S1208, the workflow platform 130 receives a list of image forming apparatuses, which are candidates for executing printing, from the print service 120.

In step S1209, the workflow platform 130 displays a list of image forming apparatuses, which are candidates for executing printing.

In step S1210, the workflow platform 130 detects that an image forming apparatus has been selected by the user.

In step S1211, the workflow platform 130 transmits a print setting obtaining request to the print service 120. Additionally, the print setting acquisition request includes information identifying the image forming apparatus.

In step S1212, the workflow platform 130 receives the print settings from the print service 120.

In step S1213, the workflow platform 130 displays the print settings.

In step S1214, the workflow platform 130 detects that a user has changed the print settings.

In step S1215, the workflow platform 130 detects that the user has changed the settings of a file to be printed.

In step S1216, the workflow platform 130 saves the settings of the print action.

The workflow platform 130 can incorporate a print action for performing printing into an arbitrary workflow in coordination with the print service 120 by executing the processes as shown in FIG. 11.

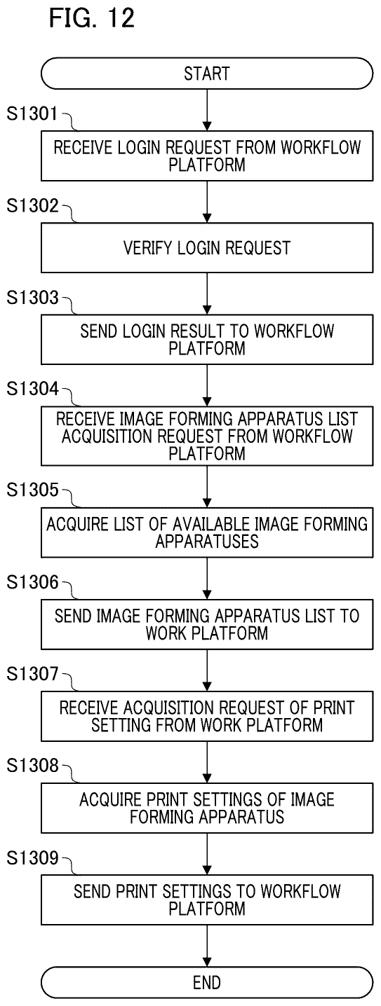

FIG. 12 is a flowchart illustrating processes executed by a print service indicating the print action in the embodiment. Specifically, FIG. 12 illustrates details of processing in which the workflow platform 130 constructs a workflow in coordination with the print service 120.

In step S1301, the print service 120 receives a login request from the workflow platform 130.

In step S1302, the print service 120 verifies the login request.

In step S1303, the print service 120 transmits the login result to the workflow platform 130. As a result, the workflow platform 130 and the print service 120 enter a state in which coordination has been completed, and can communicate with each other.

In step S1304, the print service 120 receives an acquisition request for acquiring a list of image forming apparatuses from the workflow platform 130.

In step S1305, the print service 120 acquires a list of image forming apparatuses that can be used by the workflow platform 130 from each of the image forming apparatuses managed locally. Note that an administrator of the print service 120 may individually set permission/prohibition of use in the list for at least one image forming apparatus for which the account of the print service 120 logged in by the processes from step S1301 to step S1303 can be used.

In step S1306, the print service 120 transmits the acquired list of image forming apparatuses to the workflow platform 130.

In step S1307, the print service 120 receives a print setting acquisition request from the workflow platform 130. This acquisition request includes information identifying the image forming apparatus.

In step S1308, the print service 120 identifies the target image forming apparatus from the information identifying the image forming apparatus, and acquires the print settings of the image forming apparatus. The print setting items that can be set at this time are associated with the account of the print service 120 that has logged in during steps S1301 to S1303, and may be appropriately limited by the administrator of the print service 120. For example, even in a case where double-side printing and single-sided printing are possible in the image forming apparatus when limited to only double-side printing is limited by the manager of the print service 120, only double-side printing is transmitted to the print service 120 as an item of the print setting.

In step S1309, the print service 120 transmits the acquired print settings to the workflow platform 130.

The print service 120 can perform the setting of a print action for performing printing in coordination with the workflow platform 130 by executing the processes as shown in FIG. 12.

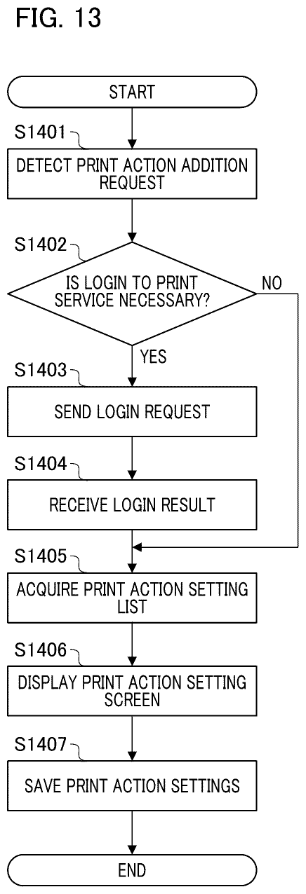

FIG. 13 is a flowchart illustrating processes executed by a workflow platform that indicates a reservation printing action in the embodiment. Specifically, FIG. 13 illustrates details of processing in which the workflow platform 130 constructs a workflow in coordination with the print service 120. In the present embodiment, an example of an action for performing a reservation printing of a file by an arbitrary printer that is managed by the print service 120 will be explained.

In step S1401, the workflow platform 130 detects a print action addition request.

In step S1402, the workflow platform 130 confirms whether or not coordination with the print service 120 that provides a print action has been already been set, and determines whether or not the login to the print service 120 is necessary. In a case where the workflow platform 130 determines that logging in to the print service 120 is necessary, the process advances to step S1403. In contrast, in a case where the workflow platform 130 determines that login to the print service 120 is not necessary, the process advances to step S1405.

In step S1403, the workflow platform 130 transmits a login request to the print service 120.

In step S1404, the workflow platform 130 receives the login result from the print service 140. Additionally, the workflow platform 130 can communicate with the print service 120 on assumption that coordination with the print service 120 has been completed, after executing the process of step S1404.

In step S1405, the workflow platform 130 acquires a list of print action settings.

In step S1406, the workflow platform 130 displays a print action setting screen.

In the reservation printing action, the setting items are different from those of the printing that has been explained with reference to FIG. 12. For example, in a case where reservation printing can be performed from an arbitrary image forming apparatus, specification of the image forming apparatus is not necessary. Additionally, in the case of the reservation printing, the print settings can also be set on the screen of the image forming apparatus before printing, and thus are not necessary. In addition, although, in the case of the reservation printing, the setting can also be performed on the screen of the image forming apparatus, the default setting of the reservation printing may be set on the workflow platform 130 in a similar manner to the setting that has been explained with reference to FIG. 12.

In step S1407, the workflow platform 130 saves the settings of the print action.

The workflow platform 130 can incorporate a print action for executing reservation printing into an arbitrary workflow in coordination with the print service 120 by executing the processes as shown in FIG. 13. Note that the print action related to the reservation printing may be referred to as a “reservation printing action”.

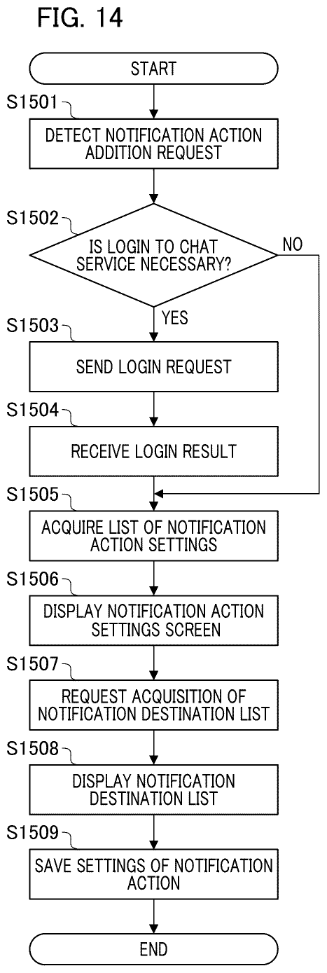

FIG. 14 is a flowchart illustrating processes executed by a workflow platform that indicates a notification action in the embodiment. Specifically, FIG. 14 illustrates details of the processing in which the workflow platform 130 constructs a workflow in coordination with the chat service 140. In the present embodiment, an example in which an action for providing a notification to a notification destination specified by the chat service 140 is constructed as an action of a workflow will be explained.

In step S1501, the workflow platform 130 detects a notification action addition request.

In step S1502, the workflow platform 130 confirms whether or not coordination with the chat service 140 that provides a notification action has already been set, and determines whether or not the login to the chat service 140 is necessary. In a case where the workflow platform 130 determines that login to the chat service 140 is necessary, the process advances to step S1503. In contrast, in a case where the workflow platform 130 determines that login to the chat service 140 is not necessary, the process advances to step S1505.

In step S1503, the workflow platform 130 transmits a login request to the chat service 140.

In step S1504, the workflow platform 130 receives the login result from the chat service 140. After executing the process of step S1504, the workflow platform 130 can communicate with the print service 120 on assumption that coordination with the chat service 140 has been completed. Note that, as described above, the account of the chat service 140 may be the same account as that of the workflow platform 130. Additionally, in a case where the account of the chat service 140 and the account of the workflow platform 130 are the same, the login for causing both to coordinate with each other is unnecessary.

In step S1505, the workflow platform 130 acquires a list of notification action settings.

In step S1506, the workflow platform 130 displays a notification action setting screen.

In step S1507, the workflow platform 130 transmits a notification destination list obtaining request to the chat service 140.

In step S1508, the workflow platform 130 receives the list of notification destinations from the chat service 140, and displays the list of notification destinations.

In step S1509, the workflow platform 130 saves the settings of the notification action.

The setting of the notification action is, for example, a setting related to a specification of a user or group of the chat service 140 of a notification destination, a specification of a channel, a type of notification, a content of notification, and a response time limit of the notification. Note that these settings of the notification action are examples, and may be settings related to other matters. The examples of the type of the notification include a printable notification, a print completion notification, a print error notification, an approval request notification, and the like, in addition to a general notification. Additionally, the approval request notification temporarily stops the workflow processing until approval is permitted. Additionally, since notification about the approval request notification can be provided even when the approval request is completed, the approval request completion notification destination can be specified, in addition to the approval request destination. Note that in a case where the above-described approval request completion notification destination is not specified, the notification destination is the client PC 111 and the like used by the user who executes the workflow.

The workflow platform 130 can coordinate with the chat service 140 and can incorporate an action for providing a notification from the chat service 140 into an arbitrary workflow by executing the processes as shown in FIG. 14.

Next, processing for executing a workflow configured by the procedures explained with reference to FIG. 9 to FIG. 14 will be explained. In the following explanation, an operation performed when a workflow for receiving approval of an estimate form, automatically printing the estimate form when the estimate form is approved, and notifying a result of the printing is executed will be described. Note that the processing to be explained next is an example, and does not limit services to be combined, service order thereof, and the like. For example, in the present embodiment, the workflow is started by using the fact that a file is saved in the cloud storage 150 as a trigger. However, for example, the workflow may be started by the fact that scanning is performed in the image forming apparatus 110 as a trigger. Additionally, in the content to be explained next, the chat service 140 may display a list of workflows constructed by the workflow platform 130.

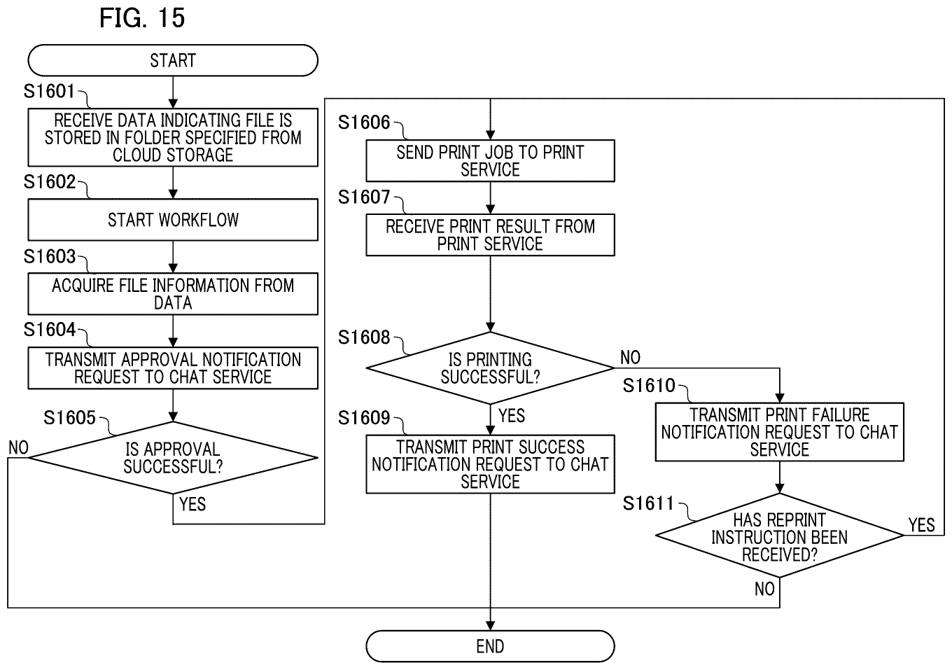

FIG. 15 is a flowchart illustrating processes executed by a workflow platform during execution of a workflow in the embodiment. Specifically, FIG. 15 illustrates an operation when the workflow platform 130 executes the workflow.

In step S1601, the workflow platform 130 receives data indicating that the file has been saved in the specified folder, from the cloud storage 150. The file is, for example, a document file of an estimate form.

In step S1602, the workflow platform 130 starts the corresponding workflow upon receiving the notification.

In step S1603, the workflow platform 130 acquires file information from the data received in step S1601. The file information is configured by a URL from which, for example, the contents of the file or the file can be downloaded, and information necessary for the print service 120 to print the file. Additionally, the information is, for example, a file name.

In step S1604, the workflow platform 130 transmits an approval notification request to the chat service 140. The approval notification request includes the notification destination set in advance in the flowchart as shown in FIG. 14 and the notification destination information after approval.

In step S1605, the workflow platform 130 determines whether or not the result of the approval request from the chat service 140 is successful. In a case where the workflow platform 130 determines that the result of the approval request from the chat service 140 is successful, the process proceeds to step S1606. In contrast, in a case where the workflow platform 130 determines that the result of the approval request from the chat service 140 is not successful, the process ends.

In step S1606, the workflow platform 130 transmits the print job to the print service 120. At this time, the workflow platform 130 transmits the file acquired in step S1603. Additionally, the printing related to the print job may be the normal printing as explained with reference to FIG. 13 or the reservation printing as explained with reference to FIG. 14.

In step S1607, the workflow platform 130 receives a print result from the print service 120.

In step S1608, the workflow platform 130 determines whether or not the print result received in step S1607 is successful. If the workflow platform 130 determines that the print result received in step S1607 is successful, the process advances to step S1609. In contrast, if the workflow platform 130 determines that the print result received in step S1607 is not successful, the process proceeds to step S1610.

In step S1609, the workflow platform 130 transmits a print success notification request to the chat service 140. The print success notification request includes the notification destination information set in advance in the flowchart as shown in FIG. 14.

In step S1610, the workflow platform 130 transmits a print failure notification request to the chat service 140. The print failure notification request includes the notification destination information set in advance in the flowchart as shown in FIG. 14.

Although, in the present embodiment, it is described that the workflow platform 130 performs successful or unsuccessful printing and notification through the chat service 140, the print service 120 may perform the similar notification processing. At this time, the notification destination is, for example, a client PC used by a user who has started the workflow, a user who has executed printing included in the workflow, or a plurality of users including these users.

In step S1611, the workflow platform 130 determines whether or not a reprint instruction has been received from the print service 120. In a case where the workflow platform 130 determines that the reprint instruction has been received from the print service 120, the process advances to step S1606. In contrast, in a case where the workflow platform 130 determines that a reprint instruction has not been received from the print service 120, the process ends.

The workflow platform 130 can execute a workflow in coordination with the print service 120, the cloud storage 150, and the chat service 140, and print a file by executing the processes as illustrated in FIG. 15.

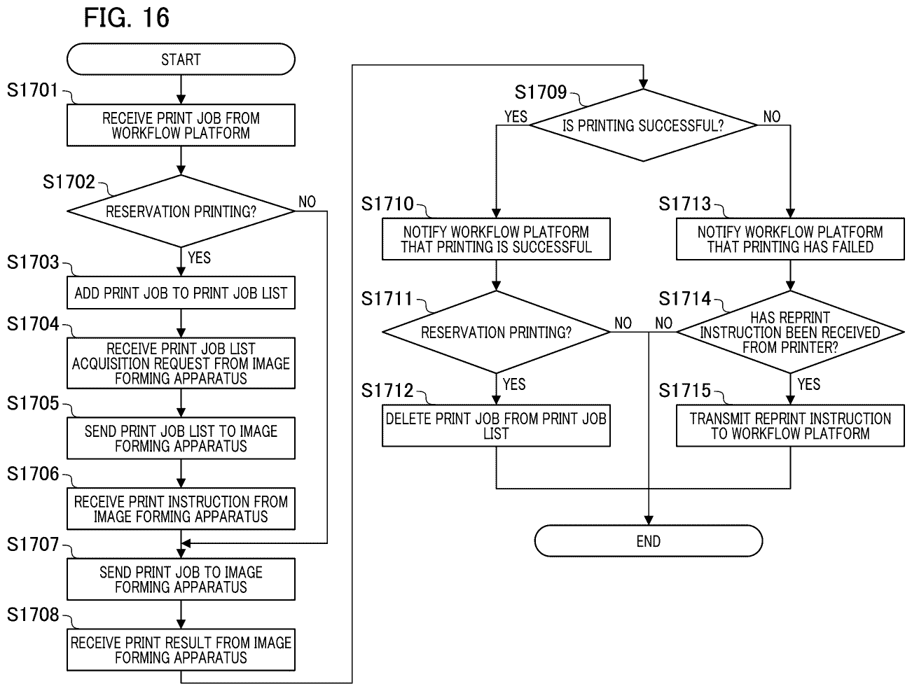

FIG. 16 is a flowchart illustrating processes executed by a print service during execution of a workflow in the embodiment. Specifically, FIG. 16 illustrates processes in which the print service 120 executes a print action in a workflow.

In step S1701, the print service 120 receives a print job from the workflow platform 130.

In step S1702, the print service 120 determines whether or not the received print job is reservation printing. If the print service 120 determines that the received job is reservation printing, the process advances to step S1703. In contrast, if the print service 120 determines that the received job is not reservation printing, the process advances to step S1707.

In step S1703, the print service 120 adds the received print job to the print job list

In step S1704, the print service 120 receives a print job list acquisition request from the image forming apparatus 110.

In step S1705, the print service 120 transmits the print job list to the image forming apparatus 110. The print job list includes a print job identifier that identifies a print job.

In step S1706, the print service 120 receives a print instruction from the image forming apparatus 110. The print instruction includes a print job identifier for specifying the print job.

In step S1707, the print service 120 specifies a print job to be transmitted from the print job identifier, and transmits the print job to the image forming apparatus 110.

In step S1708, the print service 120 receives a print result from the image forming apparatus 110.

In step S1709, the print service 120 determines whether or not the printing is successful. In a case where the print service 120 determines that the printing is successful, the process advances to step S1710. In contrast, in a case where the print service 120 determines that the printing not successful, the process advances to step S1713.

In step S1710, the print service 120 provides a notification that the printing is successful to the workflow platform 130.

In step S1711, the print service 120 determines whether or not the print job for which printing is successful is a reservation printing.

In step S1712, the print service 120 deletes the print job in which printing is successful from the print job list, and the process ends.

In step S1713, the print service 120 provides a notification that printing has failed to the workflow platform 130.

In step S1714, the print service 120 determines whether or not a reprint instruction has been received from the image forming apparatus 110. In a case where the print service 120 determines that the reprint instruction has been received from the image forming apparatus 110, the process advances to step S1715. In contrast, in a case where the print service 120 determines that the reprint instruction has not been received from the image forming apparatus 110, the process ends.

In step S1715, the print service 120 transmits a reprint instruction to the workflow platform 130.

The print service 120 can execute a workflow in coordination with the image forming apparatus 110 and the workflow platform 130 and print a file by executing the processes as shown in FIG. 16.

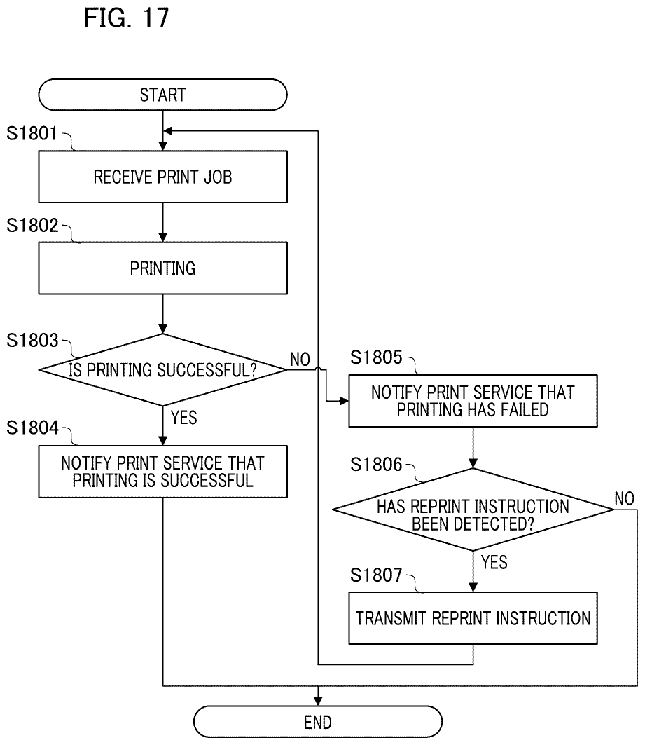

FIG. 17 is a flowchart illustrating printing processes performed by a printer during execution of a workflow in the embodiment.

In step S1801, the image forming apparatus 110 receives a print job from the print service 120.

In step S1802, the image forming apparatus 110 executes printing related to the received print job.

In step S1803, the image forming apparatus 110 determines whether or not printing is successful. In a case where the image forming apparatus 110 determines that the printing is successful, the process advances to step S1804. In contrast, in a case where the image forming apparatus 110 determines that the printing is not successful, the process advances to step S1805.

In step S1804, the image forming apparatus 110 provides a notification that printing is successful to the print service 120.

In step S1805, the image forming apparatus 110 provides a notification that printing has failed to the print service 120.

In step S1806, the image forming apparatus 110 determines whether or not a reprint instruction from the user has been detected. In a case where the image forming apparatus 110 determines that a reprint instruction from the user has been detected, the process advances to step S1807. In contrast, in a case where the image forming apparatus 110 determines that the reprint instruction by the user has not been detected, the process ends.

In step S1807, the image forming apparatus 110 transmits a reprint instruction to the print service 120.

The image forming apparatus 110 can print a file in coordination with the print service 120 by executing the processes as shown in FIG. 17.

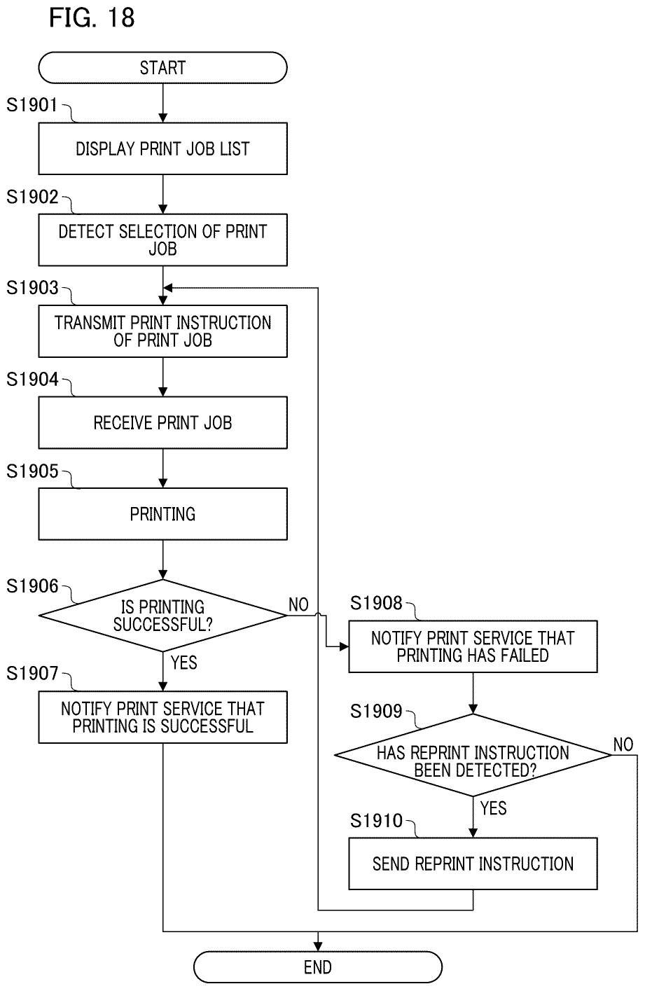

FIG. 18 is a flowchart illustrating processes of reservation printing performed by a printer during execution of a workflow in the embodiment.

In step S1901, the image forming apparatus 110 displays a print job list.

In step S1902, the image forming apparatus 110 detects that a user has selected a print job. Note that the print settings of printing related to the selected print job may be executed on the user interface of the image forming apparatus 110.

In step S1903, the image forming apparatus 110 transmits a print instruction of the detected print job.

Since steps S1904 to S1910 are similar to steps S1801 to S1807 as described above, the explanation thereof will be omitted here.

The image forming apparatus 110 can perform the reservation printing of a file in coordination with the print service 120 by executing the processes as shown in FIG. 18.

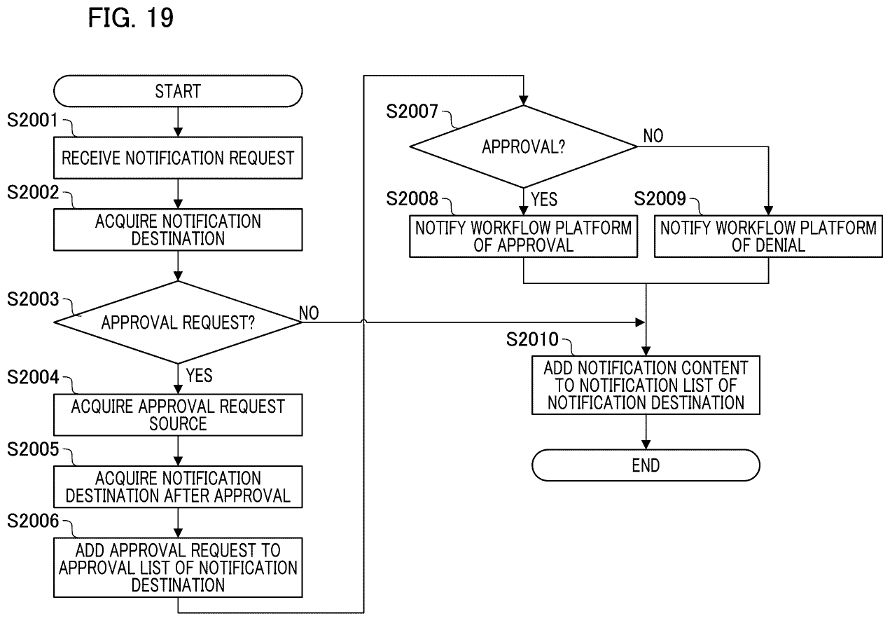

FIG. 19 is a flowchart illustrating processes in which the chat service transmits and receives a notification request during execution of a workflow according to the embodiment. Specifically, FIG. 19 illustrates the operations of approval and notification when the chat service 140 executes a workflow.

In step S2001, the chat service 140 receives a notification request from the workflow platform 130.

In step S2002, the chat service 140 acquires the notification destination included in the notification request.

In step S2003, the chat service 140 determines whether or not the notification request is an approval request. In a case where the chat service 140 determines that the notification request is an approval request, the process advances to step S2004. In contrast, in a case where the chat service 140 determines that the notification request is not an approval request, the process advances to step S2010.

In step S2004, the chat service 140 acquires an approval request source that is the request source of the approval request.

In step S2005, the chat service 140 acquires a notification destination after approval of the approval request.

In step S2006, the chat service 140 adds the approval request to the approval list of the notification destination together with the request source and the notification destination after approval. Accordingly, the chat service 140 causes the approval notification badge 510 to be displayed on the transition button 504 of the approval screen of the client PC 111 using the chat service 140. Alternatively, accordingly, the chat service 140 increases the count of the approval notification badge 510 displayed on the transition button 504 to the approval screen of the client PC 111 using the chat service 140. Then, through these processes, the chat service 140 can provide a notification that the approval request has been transmitted to the user. Additionally, the chat service 140 may display a notification regarding the approval request on a display in coordination with the client PC 111 using the chat service 140.

In step S2007, the chat service 140 determines whether or not the added approval request has been approved. If the chat service 140 determines that the added approval request has been approved, the process advances to step S2008. In contrast, if the chat service 140 determines that the added approval request has not been approved, the process advances to step S2009.

In step S2008, the chat service 140 provides a notification regarding the approval to the workflow platform 130.

In step S2009, the chat service 140 provides a notification regarding the disapproval to the workflow platform 130.

In step S2010, the chat service 140 adds the notification content to the notification list of the notification destination. Accordingly, the chat service 140 causes the notification badge 509 to be displayed on the transition button 504 of the approval screen of the client PC 111 using the chat service 140. Alternatively, accordingly, the chat service 140 increases the count of the notification badge 509 displayed on the transition button 504 of the approval screen of the client PC 111 using the chat service 140. Through these processes, the chat service 140 can make the user recognize that the notification has arrived. Additionally, the chat service 140 may display a notification regarding the approval request on a display that is in coordination with the client PC using the chat service 140.

The chat service 140 can display a notification to the user in coordination with the workflow platform 130 by executing the processes as shown in FIG. 19.

As described above, according to the present embodiment, the workflow platform 130 enables printing of a file using the image forming apparatus 110 while coordinating with the plurality of services and the print service 120.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-134351, filed Aug. 22, 2023, which is hereby incorporated by reference wherein in its entirety. The computer may comprise one or more processors (e.g., central processing unit (CPU), micro processing unit (MPU)) and may include a network of separate computers or separate processors to read out and execute the computer executable instructions.

What is claimed is:

1. A system comprising:
a workflow construction unit configured to construct a workflow that executes actions as individual processes in a predetermined order, the workflow including a print action that is a process related to printing, by using a system coordinating with a workflow platform;
a workflow execution unit configured to execute the workflow; and
a print data transmission unit configured to transmit print data indicating a printed material to be printed by the print action to an image forming apparatus in a case where the print action is executed by the workflow execution unit.

2. The system according to claim 1, wherein the workflow execution unit executes the workflow by executing the plurality of actions in a predetermined order.

3. The system according to claim 1, further comprising a list acquisition unit configured to acquire a list of the image forming apparatuses that can be used in coordination with the print data transmission unit in a case where the workflow including the print action is constructed by the workflow construction unit.

4. The system according to claim 3, wherein the list acquisition unit acquires a list of the image forming apparatuses from the print data transmission unit after confirming that the workflow platform and the print data transmission unit have already been coordinated.

5. The system according to claim 3, further comprising a print setting acquisition unit configured to acquire data related to a print setting related to the print action from the list acquisition unit according to the image forming apparatus selected from a list acquired by the list acquisition unit.

6. The system according to claim 5, wherein the print setting acquisition unit acquires data related to a print setting related to the print action by transmitting a print setting acquisition request to the print data transmission unit.

7. The system according to claim 1, wherein the workflow execution unit executes the workflow in a case where a workflow execution button provided to a client terminal by a chat service and displayed by the client terminal is pressed down.

8. The system according to claim 1, wherein the workflow construction unit constructs the workflow including the print action based on data provided to a client terminal by a chat service and input to a workflow editing screen displayed by the client terminal.

9. The system according to claim 1, wherein the workflow construction unit determines a content of the print action based on data provided to a client terminal by a chat service and input to a print action setting screen displayed by the client terminal.

10. The system according to claim 1, wherein the workflow execution unit provides a notification by using a chat service in a case where the printing is successful or in a case where the printing has failed.

11. The system according to claim 1, wherein the workflow execution unit provides a notification by using the print execution unit in a case where the printing is successful or in a case where the printing has failed.

12. The system according to claim 1, wherein the workflow execution unit provides a notification by using a chat service in a case when approval processing is executed.

13. A method comprising:
constructing a workflow that executes actions as individual processes in a predetermined order, the workflow including a print action as a process related to printing, by using a system coordinating with a workflow platform;
executing the workflow; and
transmitting print data indicating a printed material to be printed by the print action to an image forming apparatus in a case where the print action is executed.

14. A non-transitory computer-readable storage medium configured to store a computer program comprising instructions for executing following processes:
constructing a workflow that executes actions as individual processes in a predetermined order, the workflow including a print action as a process related to printing, by using a system coordinating with a workflow platform;
executing the workflow; and
transmitting print data indicating a printed material to be printed by the print action to an image forming apparatus in a case where the print action is executed.
